(19) United States
(12) Patent Application Publication
(10) Pub. No.: US 2014/0097620 A1
(43) Pub. Date: Apr. 10, 2014

(54) FLUID POWER CONVERSION DEVICE

(71) Applicant: Tzach Harari, Givatayim (IL)

(72) Inventor: Tzach Harari, Givatayim (IL)

(21) Appl. No.: 14/122,699

(22) PCT Filed: May 29, 2012
(86) PCT No.: PCT/IL2012/000210

§ 371 Date: Nov. 27, 2013

Related U.S. Application Data
(60) Provisional application No. 61/491,209, filed on May 29, 2011.

(51) Int. Cl. F03B 17/06; F03B 13/00; F03D 3/06

(52) U.S. Cl. CPC F03B 17/067; F03D 3/068; F03B 13/00
USPC 290/54; 415/33; 416/24; 416/111; 416/1; 416/85

(57) ABSTRACT

The present invention relates to a device and method for capturing the kinetic energy of a fluid and converting it to rotational, electrical or mechanical energy, the device including a rotating bar mechanism for enabling rotation of a flow-capturing blade around a central axis of the device while retaining the flow-capturing blade in an orientation perpendicular to the fluid flow direction throughout the rotation cycle.

### FIELD OF THE INVENTION

The present invention relates to power converters in general and, in particular, to a device for conversion of fluid power, such as wind or hydro power.

### BACKGROUND OF THE INVENTION

There are known in the art devices for converting fluid power into electricity. Typically, these devices include multiple blades that are fixed to a single rotating axle, like a windmill. This single rotating axle is used as the shaft to rotate the rotor of an electric generator. The force of the flow stream causes the blades to turn the single axle and power the generator. As the single axle rotates, the blades change their orientation relative to the direction of the flow.

There are also known devices with a plurality of blades where each blade is mounted for rotation about an axle. These axles are secured to a larger shaft which is used to rotate the rotor of an electric generator. The force generated by a stream of water or wind rotates the blades and turns the shaft, powering the generator.

In general these devices can be grouped as being either lift based, or drag based.

These devices often attempt to maximize the torque and the velocity at which the shaft powering the generator rotates by minimizing the resistance of the blades to the flow stream. In order to do so, they allow their blades to rotate about their axles and change their orientation in relation to the horizontal direction of the stream.

However, none of these devices succeeds in utilization of the power of the fluid flow to the maximum.

Accordingly, there is a long felt need for a relatively simple and cost effective device for converting fluid kinetic power to rotational power, and possibly electric power, in an efficient way that maximizes the torque produced from the fluid and minimizes turbulence, whirling and friction.

### SUMMARY OF THE INVENTION

In a fluid turbine, the orientation and the cross-section of the blade presented in front of the fluid are critical to the turbine's efficiency. It has now been determined that, for turbines that are rotated in the direction of a fluid's flow, in order to generate the maximum amount of torque, the blades of the turbine would be required to remain in a constant vertical orientation, substantially perpendicular to the flow direction at any rotation angle. This setup would effectively maximize the contact surface facing the flow, in order to maximize the force production and minimize turbulence, whirling and friction, by fixing the blade at a right angle to the flow and achieving smooth rotation in the fluid.

According to the present invention, there is provided a device for capturing the kinetic energy of a fluid and converting it to rotational energy and, thence, to electrical or mechanical energy, where the blades of the device are retained in an orientation perpendicular to the direction of a fluid flow at all rotation angles. This is accomplished by means of a device including a turbine rotatably mounted about two axles for converting fluid stream energy to rotational energy, the turbine including, two rotating bar mechanisms (each having a frame shaped like a parallelogram) and at least one flow-capturing blade coupled between the two rotating bar mechanisms, for enabling rotation of the blade around a central axis of the turbine, while also retaining the blade in an orientation substantially perpendicular to the direction of fluid flow throughout the rotation of the turbine. According to some embodiments, the device further includes a generator for converting the rotational energy generated by the rotation of the blade into electric energy.

According to some embodiments, the turbine includes two pairs of coupling joints, each coupling joint including two short vertical bars, each having upper and lower portions, wherein the lower portions of the short vertical bars are fixedly coupled to a first axle, wherein the upper portion of a first of said short vertical bars is fixedly coupled to a second axle, a first rotating long bar pivotally mounted on said first axle in a gap between said short vertical bars; and a second rotating long bar pivotally mounted on said second axle; wherein one of said at least one flow-capturing blade fixedly mounted between the second of said two short bars of one coupling joint and a second of said two short bars of an adjacent joint.

In accordance with the invention, there is also provided a method for capturing the kinetic energy of a fluid and converting it to rotational energy. The method includes the steps of providing a turbine including at least one flow-capturing blade, disposing the turbine in a fluid flow; and maintaining the flow-capturing blade in an orientation substantially perpendicular to a direction of the fluid flow at all times.

### BRIEF DESCRIPTION OF THE DRAWINGS

The present invention will be further understood and appreciated from the following detailed description taken in conjunction with the drawing in which:

FIG. 1 is an isometric view of a device for converting fluid power to electricity, constructed and operative in accordance with one embodiment of the present invention;

FIG. 2 is a front view of the device of FIG. 1;

FIG. 3 is a sectional view taken along line A-A in FIG. 2;

FIG. 4 is a detail view of a bar mechanism of the device of FIG. 1;

FIGS. 5a-5b are detail views of the bar mechanism of FIG. 4 in various stages of rotation;

FIGS. 6a-6h are schematic illustrations of the blades of the device of FIG. 1 during a rotation cycle;

FIGS. 7a-7c are isometric views of a device for converting fluid power to electricity, according to an alternative embodiment of the invention;

FIGS. 8a-8h are schematic illustrations of the blades of the device of FIGS. 7a-7d during a rotation cycle;

FIGS. 9a-9b are isometric views of a device for converting fluid power to electricity, according to an alternative embodiment of the invention;

FIG. 10 is a detail view of an alternative embodiment of the device of FIG. 1, including a barrier;

FIG. 11 is an isometric view of a device for converting fluid power to electricity according to another alternative embodiment of the invention;

FIG. 12 is an isometric view of a device for converting fluid power to electricity according to a further embodiment of the invention;

FIGS. 13a-13b are isometric views of a device for converting fluid power to electricity according to another alternative embodiment of the invention; and

FIG. 14 is a side view of the device of FIG. 7a.

### DETAILED DESCRIPTION OF THE INVENTION

The present invention relates to a device and method for conversion of kinetic energy, in the form of fluid stream power, into rotational energy by using a novel rotating mechanism which maintains the flow-capturing blades of the device in a constant orientation, substantially perpendicular to the direction of the fluid flow, regardless of the rotation angle of the rotating mechanism. This maximizes the torque generated by the rotation of the rotating mechanism and enables the capture of the fluid's linear momentum in a very efficient way, converting the kinetic energy of the fluid into rotational energy. This rotational energy may then be converted to electricity by means of an electric generator, or it can be used to power a mechanical device, or used for any other desired use.

The rotating mechanism and flow-capturing blades of the invention form part of a turbine, particularly a drag force turbine, which provides a constant maximal cross-section in front of the fluid stream in order to convert the fluid stream's momentum into torque. In embodiments where the device is disposed in more than one type of fluid (e.g., water and air), the rotating mechanism enables a smooth penetration of the blades into each fluid. The turbine is thereby able to translate the linear kinetic energy of the fluid stream to rotational energy.

According to one embodiment of the present invention, this turbine includes at least two flow-capturing blades which are retained between at least two rotating frames, which preferably are symmetric rotating bar frames having the shape of parallelograms. The shape and joints of the rotating frames enable a full 360° rotation cycle of the flow-capturing blades around a central axis while maintaining the flow-capturing blades in a constant vertical orientation, regardless of the rotation angle of the rotating bar mechanism. Preferably, a transmission system, which may include a rotated wheel or shaft and/or a gearing system, helps deliver the rotational energy to at least one generator for producing electricity. It will be appreciated that any known means for transferring rotational energy, such as a pulley, shaft or flywheel, may be used in place of or in addition to the wheel.

It will be appreciated that the invention can be adjusted to work with all types of fluids, particularly air, for converting wind power to electricity, and water, for converting hydro power to electricity.

According to certain embodiments, where the invention is used for converting hydro power to electricity, the device also includes a buoying system that supports the rotating mechanism and permits the device to turn according to the water flow direction. According to some embodiments, the buoying system supports the uniquely shaped turbine that converts the fluid stream energy into rotational energy. That is, the rotating bar mechanisms, the generators and the gearing system are all supported on the buoys. Preferably, an electric cable is provided to deliver produced electricity to an onshore electrical network. Alternatively, the produced electricity can be stored in any known means for storing electricity for later use, such as a replaceable battery, or a pumped storage device to pump the water to a high reservoir and store it in the form of water's potential energy. If desired, the electrical generator can be disposed on shore, while the buoys support only the rotating mechanism in the water. In other embodiments, the produced electricity may be used for water desalination. Preferably, the device also has means, such as a cable, for anchoring the device to the water bottom while allowing it to self adjust according to the flow direction.

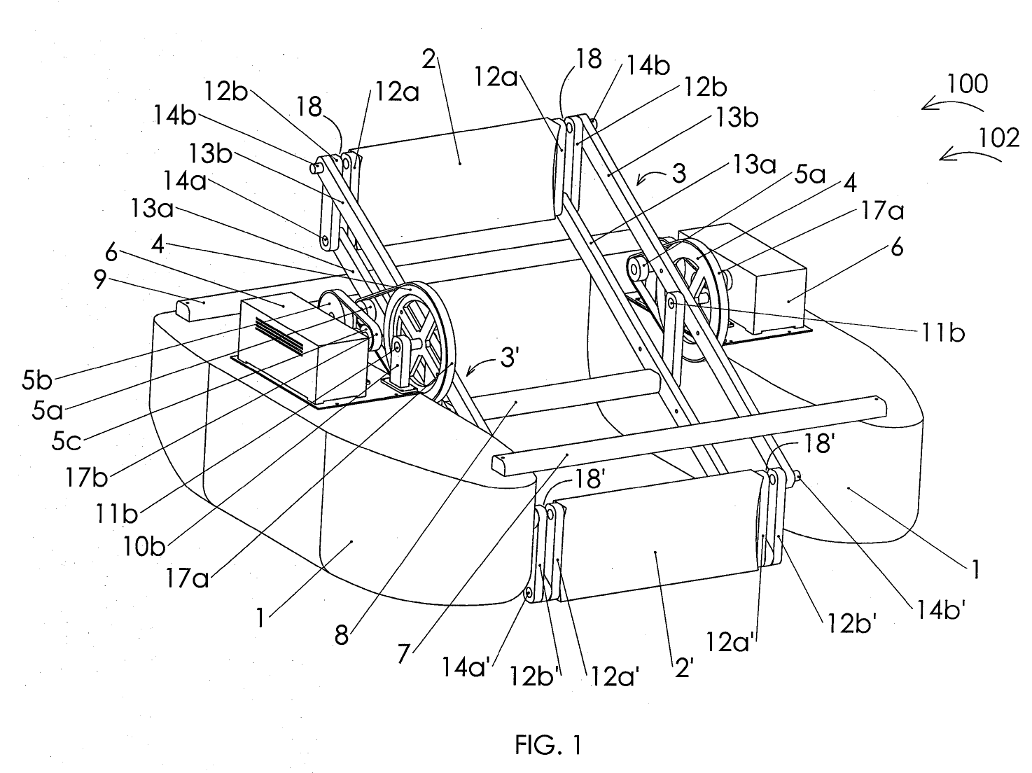

One embodiment of a device 100 for converting fluid flow power, according to the present invention, is illustrated in FIGS. 1 to 4, wherein the device 100 is a semi-submerged floating structure. Device 100 has a single turbine 102 formed of two symmetric rotating bar mechanisms 3, 3′ and two flow capturing blades 2, 2′ affixed therebetween on four coupling joints on the corners.

According to the illustrated embodiment shown in FIGS. 1-4, device 100 floats above water level supported on the two buoys 1, which, preferably, have a catamaran shape that creates a very stable structure. The volume and shape of the two buoys 1 are designed to maintain the device floating at the correct level, preferably with the rotating bar mechanisms 3, 3′ mostly out of the water, to enable efficient operation of the turbine 102. The device also includes three structural bars: a forward and a rear structural bar 7 and 9, to connect the two buoys 1, and an optional reinforcing structural bar 8, to connect the two symmetric rotating bar mechanisms 3, 3′ to create a wide and stable structure. The device is preferably connected to the water bottom by at least one cable (not shown), which enables the device to pivot and self adjust relative to the water flow. In other words, the cable allows the device the freedom to move based on the direction of the stream, and therefore, it will automatically pivot or move to face in the direction for achieving optimal efficiency. In other embodiments, where the direction of the fluid flow is constant, the device can be anchored to the ground with a rigid support.

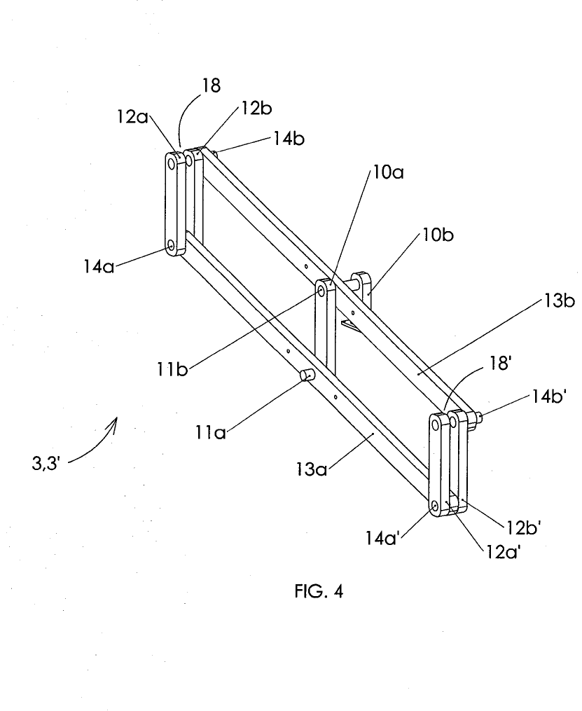

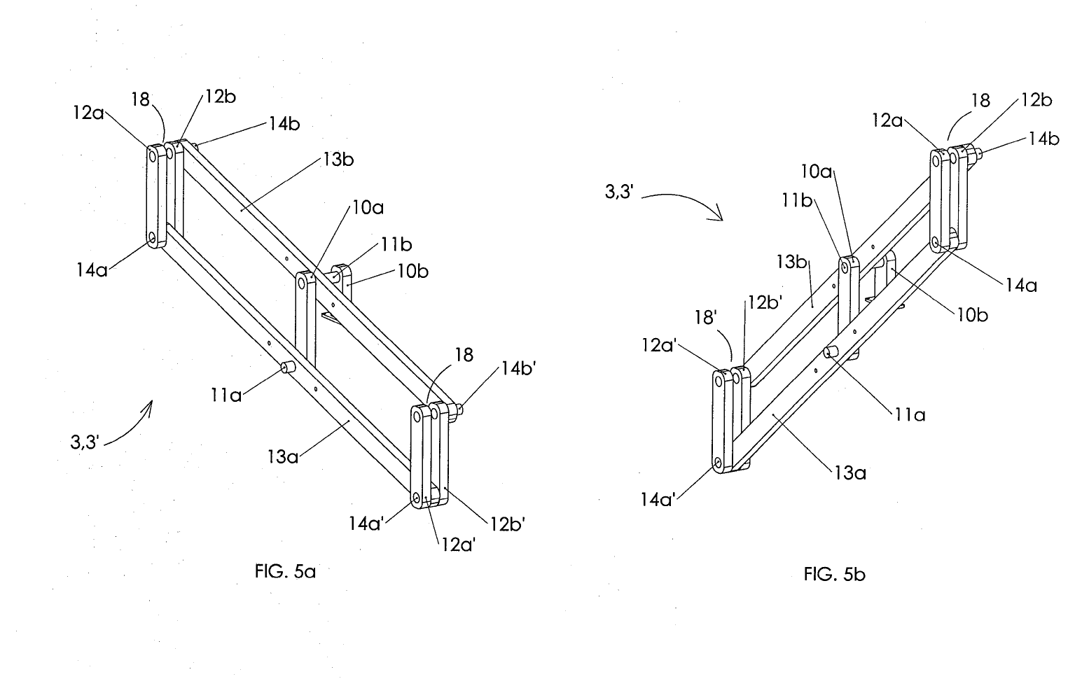

In this embodiment, each individual bar mechanism 3 or 3′ (best seen in FIG. 4) contains three pairs of vertical short bars, a central pair 10a, 10b and two distal pairs 12a, 12b, 12a′, 12b′, two rotating long bars 13a, 13b and two static horizontal shafts 11a, 11b. Vertical short bars 10a, 10b help connect bar mechanisms 3, 3′ to buoy 1, while the other two pairs of vertical short bars 12a, 12b, 12a′, 12b′ help connect bar mechanisms 3, 3′ to blades 2, 2′.

An exterior vertical short bar 10b is rigidly mounted on buoy 1 by any known mounting means (such as screws or welding). An exterior static horizontal shaft 11b is affixed between the upper inner end of exterior vertical short bar 10b and the upper outer end of an interior vertical short bar 10a, forming a central axle about which an outer rotating long bar 13b will rotate. An interior static horizontal shaft 11a is rigidly mounted on the lower inner end of interior vertical short bar 10a and serves as an axle about which the inner rotating long bar 13a will rotate.

A pulley or wheel 4 is rigidly mounted to outer rotating long bar 13b by any known mounting means, for example screws or bolts or welding, so that wheel 4 rotates together with outer rotating long bar 13b. Alternatively, in place of a wheel, a pulley, shaft or other rotated element, may be used to deliver the rotational energy to the generator. A flywheel may be provided to help the device achieve high inertia, a unified speed rotation, to prevent the stalling of the device, and to store rotational energy.

A gearing system may be used to help regulate the rotation velocity to achieve the correct speed for the generator 6. In the embodiment illustrated in FIGS. 1-4, gearing system, driven by the rotation of the outer rotating long bar 13b and wheel 4, includes a first pulley 5a, second pulley 5b, third pulley 5c, first belt 17a and second belt 17b. Wheel 4 is connected to first pulley 5a by means of first belt 17a, which is rotatably mounted on wheel 4 and first pulley 5a. A first shaft (not shown), or other known means, is rigidly mounted between first pulley 5a and a second pulley 5b, so that when first pulley 5a is rotated, second pulley 5b is also rotated. Second pulley 5b is connected to third pulley 5c by means of second belt 17b, which is rotatably mounted on second pulley 5b and third pulley 5c. Third pulley 5c is connected to generator 6 as by means of a second shaft (not shown), so that, when it rotates, it powers generator 6 with its rotational energy. The rotation of rotating bar mechanism 3, 3′ particularly outer rotating long bar 13b, thereby powers generator 6, converting the rotational energy of turbine 102 to electricity.

According to alternative embodiments, any number of wheels, flywheels, pulleys, belts, gears, and/or secondary shafts/axles may be added to or omitted from the gearing system. It will be appreciated that no gearing system is required. In the absence of a gearing mechanism, the rotational energy is transmitted directly from rotating bar mechanism 3, 3′ to generator 6.

With further reference to FIGS. 1 to 4, the inner and outer rotating long bars 13a and 13b are mounted on their respective static horizontal shafts 11a and 11b, with the horizontal shafts 11a and 11b passing through bores (not shown) in a middle section of each of the rotating long bars 13a and 13b. In this way, the middle section of outer rotating long bar 13b is rotatably mounted on exterior static horizontal shaft 11b, and the middle section of inner rotating long bar 13a is rotatably mounted on interior static horizontal shaft 11a. Bearing joints (not shown) are preferably provided between the horizontal shafts 11a, 11b and the rotating long bars 13a, 13b to help enable the rotation of the rotating long bars 13a, 13b around the horizontal shafts 11a, 11b.

The turbine 102 further includes four coupling joints. Each coupling joint includes two short vertical bars, e.g., 12a and 12b, having upper and lower portions. The lower portions of the short vertical bars are fixedly coupled to an axle, e.g., 14a. The upper portion of short vertical bar 12b is fixedly coupled to and axle, e.g., 14b. A distal end of rotating long bar 13a is pivotally mounted on axle 14a in a gap 18 between short vertical bars 12a and 12b. A distal end of rotating long bar 13b is pivotally mounted on axle 14b. A flow-capturing blade is fixedly mounted between short bar 12a of one joint and 12a of an adjacent joint (in registration therewith).

More specifically, each distal end of outer rotating long bar 13b is rotatably mounted about an exterior axle 14b, 14b′, which is rigidly mounted to the upper outer end of an exterior vertical short bar 12b, 12b′, with each exterior axle 14b, 14b′ passing through bores (not shown) in the distal ends of the outer rotating long bar 13b. Each distal end of inner rotating long bar 13a is rotatably mounted about an interior axle 14a, 14a′, which is rigidly mounted between the lower inner end of an outer vertical short bar 12b, 12b′ and the lower outer end of an inner vertical short bar 12a, 12a′, each interior axle 14a, 14a′ passing through throughgoing bores (not shown) in the distal ends of the inner rotating long bar 13a.

It will be appreciated that both rotating long beams 13a, 13b are able to rotate through a full 360° circle around their axles 14a, 14a′, 14b, 14b′. As can be seen, between each pair of vertical short bars 12a, 12b and 12a′, 12b′ a gap 18, 18′ is defined between the upper outer end of interior vertical short bar 12a, 12a′ and the upper inner end of exterior vertical short bar 12b, 12b′.

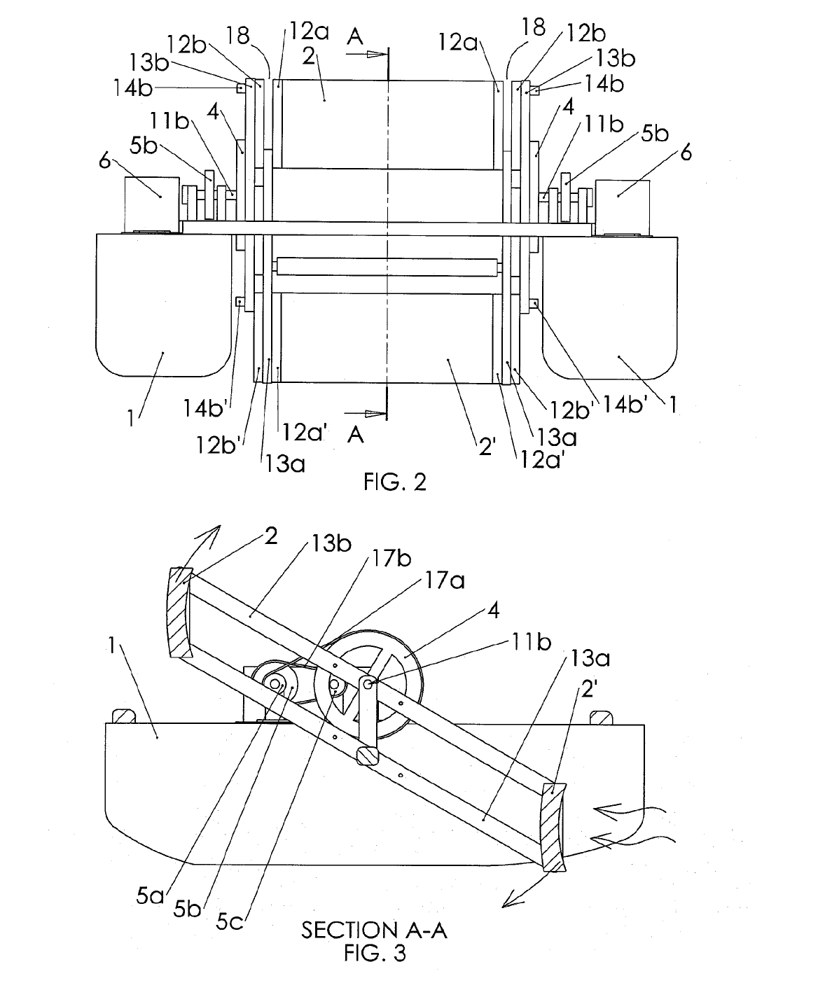

As shown in FIGS. 1 and 2, each blade 2, 2′ is fixedly mounted on both its left and right outer edges between two symmetric bar mechanisms 3, 3′. Each of the outer edges of blade 2, 2′ is rigidly connected, at least at its top and bottom ends, to one of the interior vertical short bars 12a, 12a′. Thus, the two flow-capturing blades 2, 2′ are thereby symmetrically arranged on the rotating bar mechanisms 3, 3′. It will be appreciated that a symmetric arrangement of the structure is the most efficient but it is not a requirement.

Blades 2, 2′, interior vertical short bars 12a, 12a′ and exterior vertical short bars 12b, 12b′ are rigidly connected to each other by any known means, such as welding. In certain embodiments, blade 2, 2′ may be mounted on one or more horizontal shafts (not shown) that are fixedly mounted between each set of interior vertical short bars 12a, 12a′. According to other embodiments, interior vertical short bars 12a, 12a′ may be omitted completely, and blades 2, 2′ may be connected directly to interior axles 14a, 14a′ and exterior vertical short bars 12b, 12b′.

Preferably, the outer surface of flow-capturing blades 2, 2′ has a concave shovel shape for better capturing the water kinetic energy. According to certain embodiments, both front and rear surfaces of the flow-capturing blades 2, 2′ have a concave shape, in order to enable efficient rotation and stream conversion in both directions (both clockwise and counter clockwise). Flow capturing blades may be made from any suitable rigid or flexible material in order to create a rigid blade or a pliable sail, as desired.

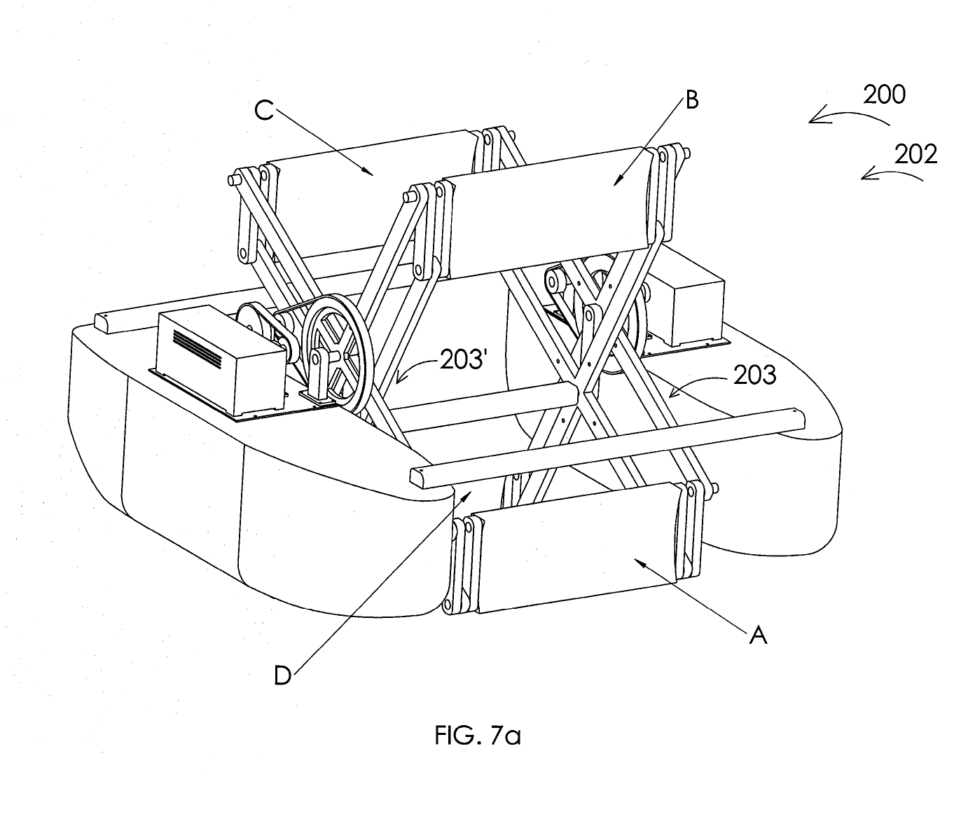

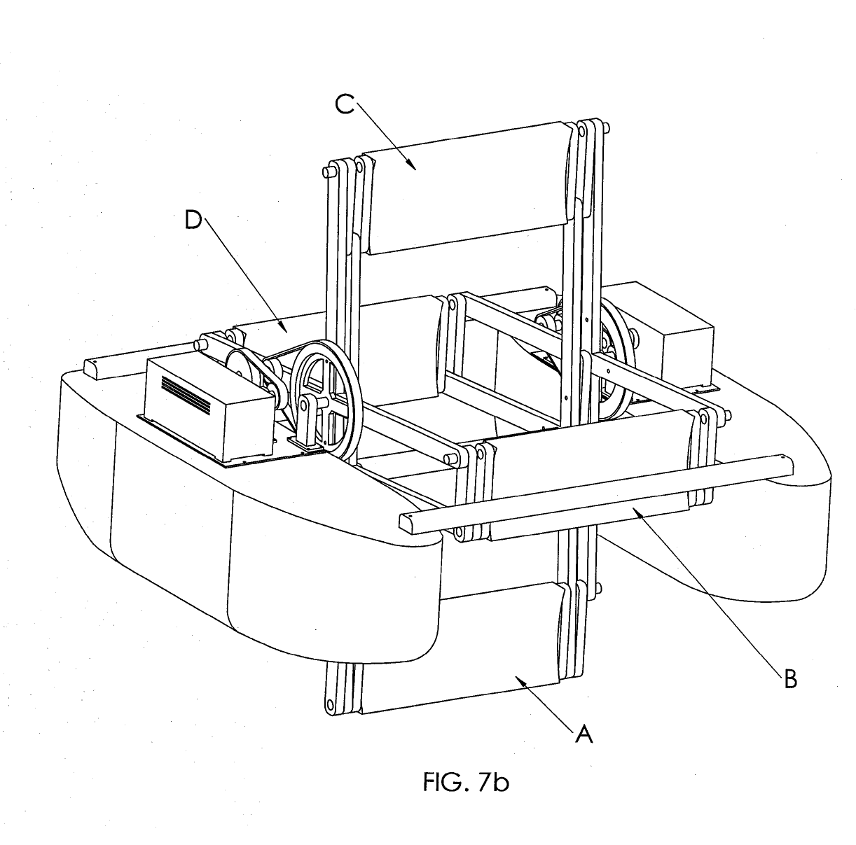

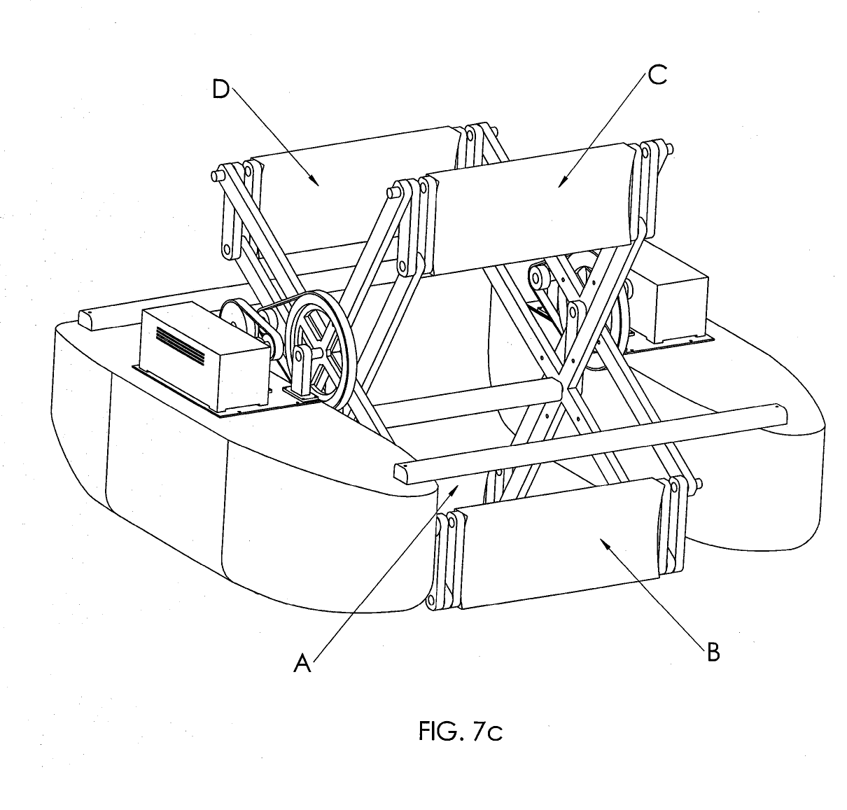

The operation of the device illustrated in FIGS. 1-4 is as follows. The device is placed in a fluid stream so that the linear force of the fluid flow (kinetic energy) acts upon and pushes against the surface of blades 2, 2′. The vertical short bars 12a, 12b, 12a′, 12b′ support the blades 2, 2′ so that they remain in an orientation substantially perpendicular to the direction of fluid flow. However, the linear force of the kinetic energy pushing against the surface of the blades 2, 2′ causes the rotating long bars 13a and 13b to rotate about their central axles 11a, 11b and, at their distal ends, about their axles 14a, 14a′, 14b, 14b′. During each 360° rotation, the end portions of inner rotating long bar 13a pass through gap 18 between the top outer edge of interior vertical short bar 12a and the top inner edge of exterior vertical short bar 12b, and through gap 18′ between the top outer edge of interior vertical short bar 12a′ and the top inner edge of exterior vertical short bar 12b′, as it rotates in a complete circle about its central axle. This operation can be seen more clearly in FIG. 7b, described below with regard to a different embodiment.

Wheel 4 is fixedly mounted on outer rotating long bar 13b so that the rotation of the bar mechanism 3, 3′ is transmitted to wheel 4, and through wheel 4 to first belt 17a and first pulley 5a. As first pulley 5a rotates, it causes the first shaft/axle (not shown), fixedly mounted between first pulley 5a and second pulley 5b, to rotate, thereby causing second pulley 5b to rotate. The rotation of second pulley 5b causes second belt 17b and third pulley 5c to rotate. A second shaft/axle (not shown), which is mounted on third pulley 5c, rotates along with third pulley 5c and transmits that rotational energy directly to the rotor (not shown) of an electrical generator 6.

It will be appreciated that in alternative embodiments, wheel 4 may be designed as a flywheel for high inertia, and gears may be used in place of pulleys and belts.

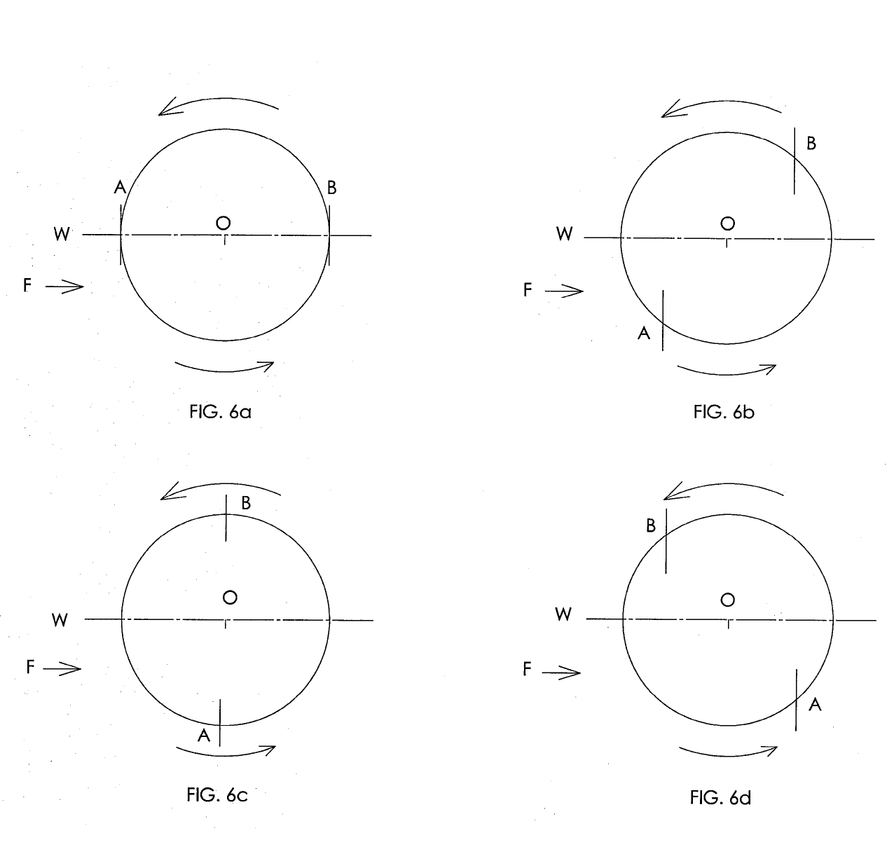

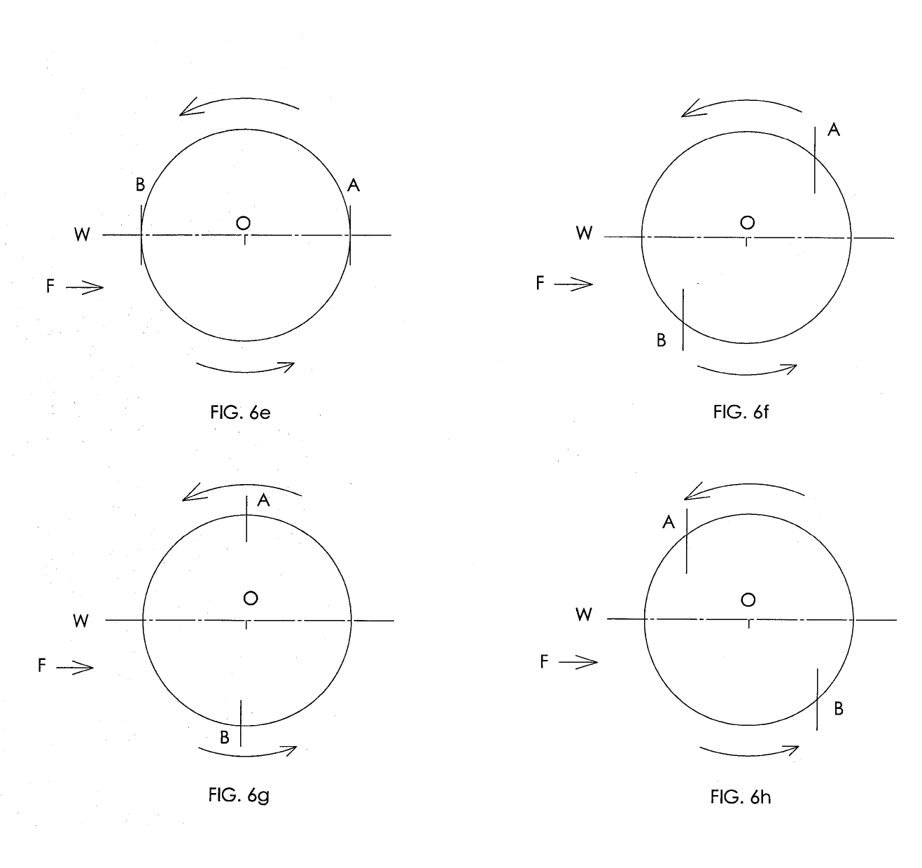

FIGS. 6a-6h are diagrams illustrating schematically the position of blades A and B during a rotation cycle of a device built according to the embodiment illustrated in FIGS. 1-4. In FIGS. 6a-6h, blades A and B, which are essentially the same as blades 2, 2′, are rotated about an axle in the direction of the arrows by the flow F of a fluid. Blades A and B are also shown passing through a boundary W separating two types of fluid, such as water and air. For this example, the medium above boundary W is air and the medium below boundary W is water. It will be noted that in other embodiments, there may be only one type of fluid, e.g. air. As shown in FIG. 6a, blade A remains in a vertical orientation, perpendicular to the horizontal direction of the flow F, as it penetrates boundary W and enters the water. At the same time, blade B remains in a vertical orientation, perpendicular to the flow as it exits the water at boundary W and enters the air. The force of the fluid flow F acts on the surfaces of blades A and B inside the water and causes the rotating bar mechanisms securing them to rotate in the direction of the arrows until the blades reach the position shown in FIG. 6b. FIG. 6b shows blades A and B as they continue to pass through their respective fluids while maintaining their vertical orientation. In this example, the force of the fluid flow F of the water acting on blade A causes the blades to continue their rotation cycle until they reach the position shown in FIG. 6c. In FIG. 6c, blades A and B have reached −90° and 90° angles, respectively. After this point the force of gravity acting on blade B will assist the force of the fluid flow F acting on blade A as the mechanism continues to rotate them to the position shown in FIG. 6d. From FIG. 6d, blades A and B will continue to rotate to the position shown in FIG. 6e. It will be appreciated that the position shown in FIG. 6e is substantially the same as the one shown in FIG. 6a, except with blade B penetrating the water and blade A entering the air. It will also be appreciated that the rest of the rotation cycle, shown in FIGS. 6f-6h, will continue in a manner similar to the one shown in FIGS. 6b-6d and described above, until the blades return to the position shown in FIG. 6a and begin the cycle again.

Thus, torque is obtained from the fluid acting against each flow-capturing blade 2, 2′, throughout almost 180° of its travel in the water. The flow-capturing blades 2, 2′ deliver this torque to the bar mechanisms 3, 3′ which transfer it to the generator 6. This means that power is obtained from the water throughout almost 360° of rotation in a rotation cycle by the two flow-capturing blades 2, 2′. It is a particular feature of the invention that each of the flow-capturing blades A and B remains in an orientation substantially perpendicular to the direction of fluid flow through the entire rotation cycle of the rotating bar mechanism: while penetrating the water, traveling through the water, leaving the water and continuing through the air until once again penetrating back into the water. This enables a smooth and highly efficient rotation of the rotating bar mechanism in the fluid with minimal turbulence, whirling and friction.

Since the water's specific weight is much higher than the air's specific weight, the force of the water flow acting on the flow-capturing blade A, while it passes through the water, is significantly higher than the force of the air acting on flow-capturing blade B, while it passes through the air. This, together with the fact that the water flow presses against the perpendicular flow-capturing blades whereas the air provides minimal resistance in many locations, enables the device to work in a closed cycle to convert the water kinetic energy to rotation and produce electricity efficiently.

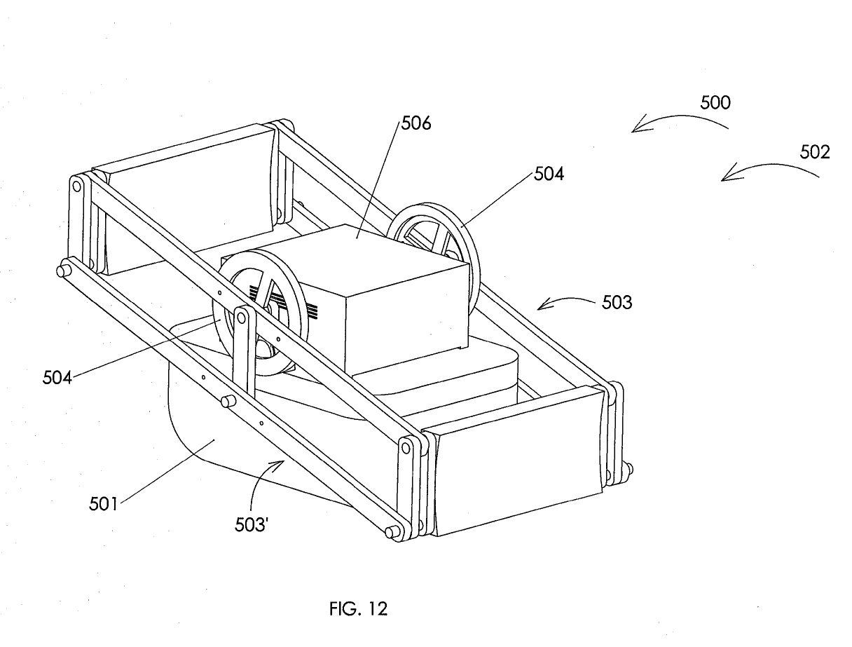

According to some embodiments, shown, by way of example only in FIG. 10, a barrier 1000 may be provided for blocking wind flow from reaching the flow-capturing blade 2, 2′ as it travels through the air. Barrier 1000 helps ensure that there is minimal flow resistance to the flow-capturing blade 2, 2′ as it travels through the air and back towards the water. It will be appreciated that barrier 1000 may be designed as a full hood covering the entire top portion of the device, as illustrated, or as a partial hood for providing partial coverage.

It will be appreciated that the design of the rotating bar mechanisms 3, 3′ in particular their ability to retain the flow-capturing blades 2, 2′ perpendicular to the flow direction at any rotation angle, enables turbine 102 to rotate with minimal power losses due to friction, mixing and whirling currents. This enables a very efficient device for converting the fluid kinetic power to electric power. Furthermore, the axis-symmetric shape of the rotating bar mechanisms 3, 3′ helps achieve a balanced system and continuous rotation.

It will be noted, that instead of being fixedly mounted on the bars, any or all of the fixed shafts or axles may alternatively be integrally formed with the bars.

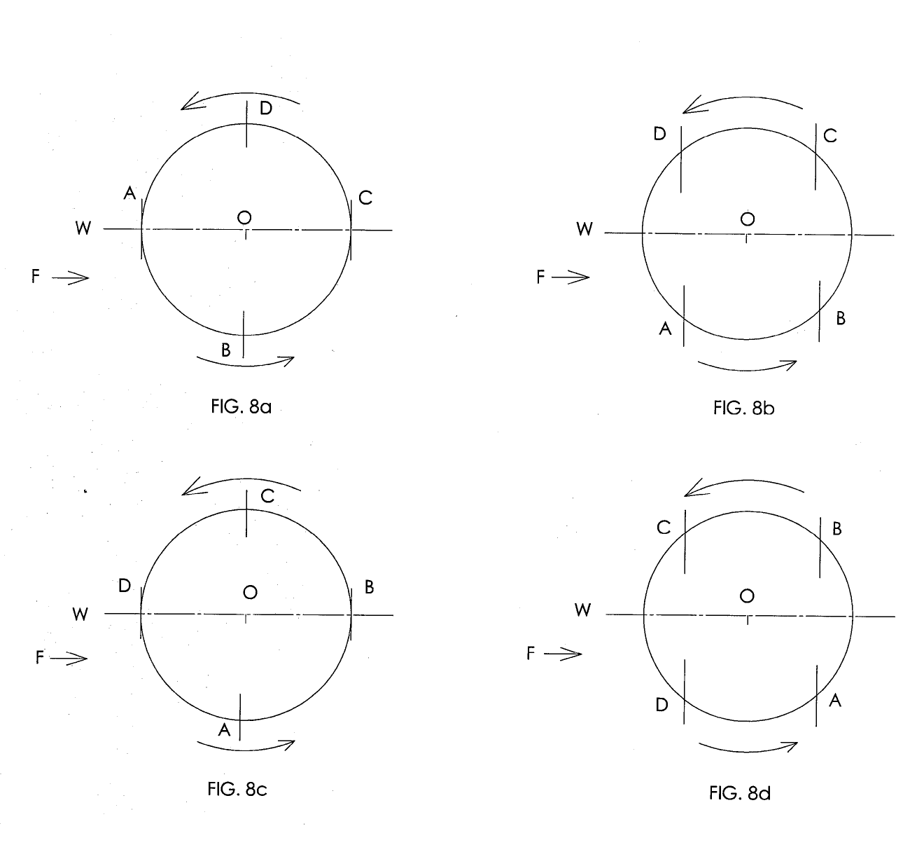

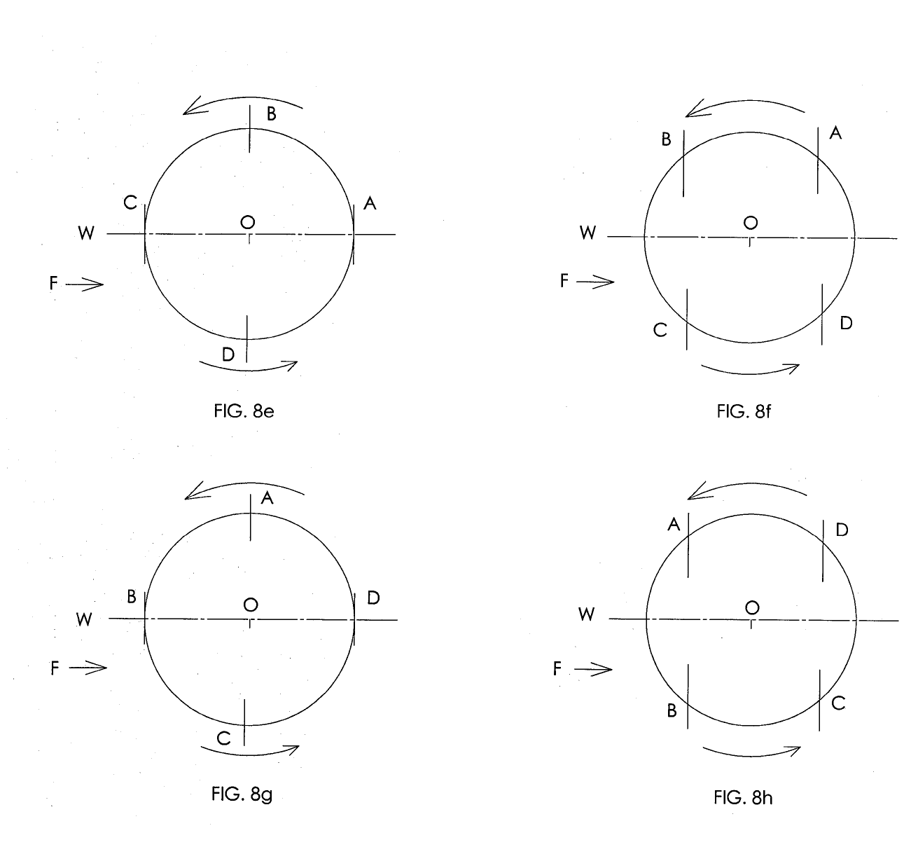

FIGS. 7a-7c illustrate a conversion device 200 according to another embodiment of the present invention. Device 200 is similar to the device shown in FIGS. 1-4, except that device 200 has a double turbine 202. Turbine 202 is formed of two rotating mechanisms 203, 203′ and four flow capturing blades A, B, C and D affixed therebetween. Each rotating mechanism 203, 203′ is formed of a pair of rotating bar mechanisms which have been rigidly mounted or integrally formed together. This design provides increased torque relative to the embodiment having only two flow-capturing blades. Operation of the embodiment shown in FIGS. 7a-7c is similar to that shown in FIGS. 1-4. FIGS. 8a-8h are diagrams illustrating the operation of blades A, B, C and D during a rotation cycle of device 200 built according to the embodiment illustrated in FIGS. 7a-7c. In this way, portions of two blades are in the water at all times.

The size and dimensions of the device of the present invention can be scaled and designed to fit small or large stream sources, such as ocean currents, tidal flows, river channel currents and other similar environments. Depending on the intended use, the length of the device can be scaled anywhere from less than a meter to tens of meters. The device can also be installed in channels and in pipes. The device of the present invention can be installed at a site as a single unit, or as a plurality of units arranged in an array. The device may include means, such as a cable, for connecting at least two of these units so that they may be moved in tandem. In addition, the invention's robust design and ability to adjust to the surrounding environment are major properties that fit it to the aggressive environment of oceans and rivers. According to preferred embodiments, all the electrical parts and gearing systems are located above the water level. This permits energy capture from a fluid when the majority of the components are located outside of the fluid, which enables simplicity of design and better maintenance.

In addition to using the device of the invention in natural or artificial stream sources, such as a river or a treatment plant's waste water, the stream source used to feed the device can be designed deliberately for use with the device. In this case, the canal shape and structure can be designed to fit the device, as well as its support system. Also, in order to reach the maximal efficiency of the device, the complete flow system might include other flow elements, like pipes and closed conduits, to control the pressure and the flow-rate, and to enable a closed loop flow as part of the complete system design for higher effectiveness.

The flexible design of the invention enables a simple installation, especially when the device is intended for water use, suitable for use in offshore locations. In these embodiments, the production process may be performed in a factory, with the final assembly being made anywhere, e.g. in the factory, on a shore, or on a canal bank. The device is then preferably launched into the water and dragged to the desired site, as by a boat. At the desired site, the simple installation is completed by anchoring the device to the water bottom with cables, and connecting the generator(s) to on-shore electrical components, such as an electricity inverter or transformer, with electric cables. This simple anchoring connection reduces the impact on the ecosystem and makes the installation process flexible and simple. In other configurations, the device can be anchored to the desired site by a rigid support connected to the water bed or canal banks, when deploying in rivers or channels. Also, instead of connecting the generators to on-shore electrical components, an electricity storage system, such as at least one battery, may be provided to store the electricity generated by the device.

It will be appreciated that when used in the water, the present invention overcomes major obstacles in the marine environment, such as building a massive structure and positioning it offshore. Also, the components of the device are preferably made of metals or polymers that fit the marine environment, in order to have a minimal interference with the ecosystem. The flow capturing blades may be designed as sails (rigid or flexible) for maximal strength with minimal material. This unique design helps enable it to become a breakthrough technology for producing electricity from flowing water, in general, and from marine currents in particular.

Additionally, the environmental impact of the device of the invention is mild when it is used in any fluid, since the rotating bar mechanism is preferably rotated at a low velocity and since its structure, according to preferred embodiments, does not include any closed housing that might impact the biological environment.

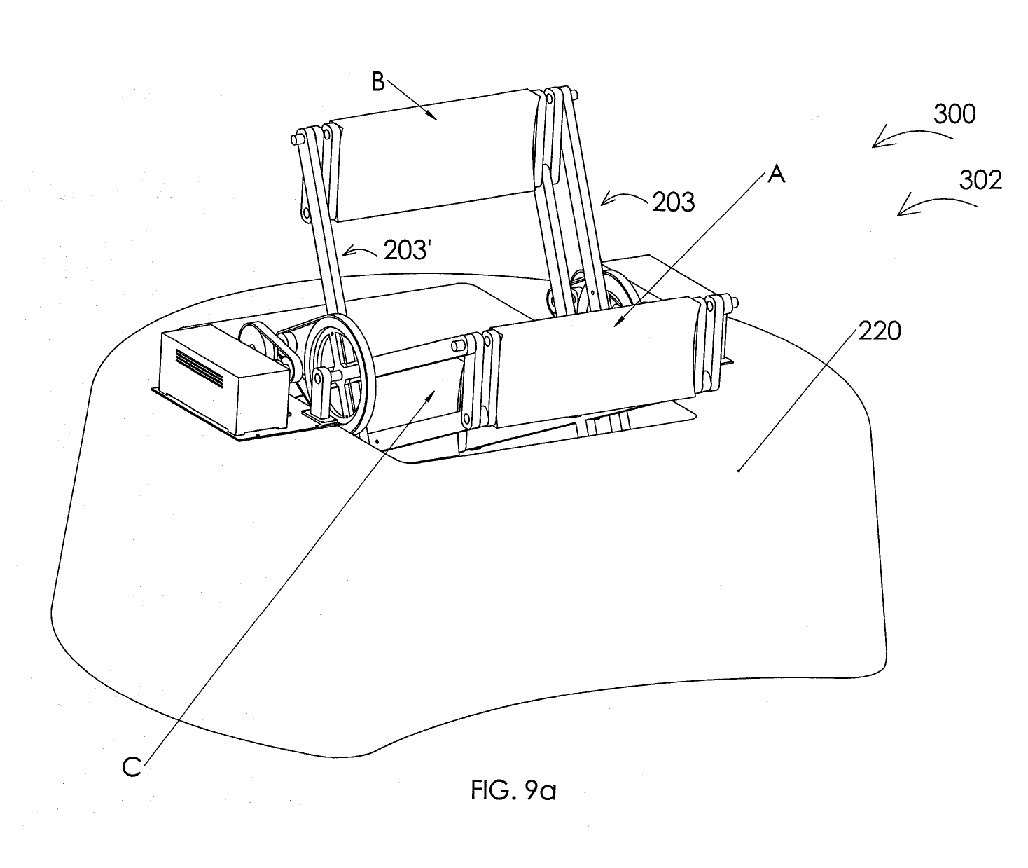

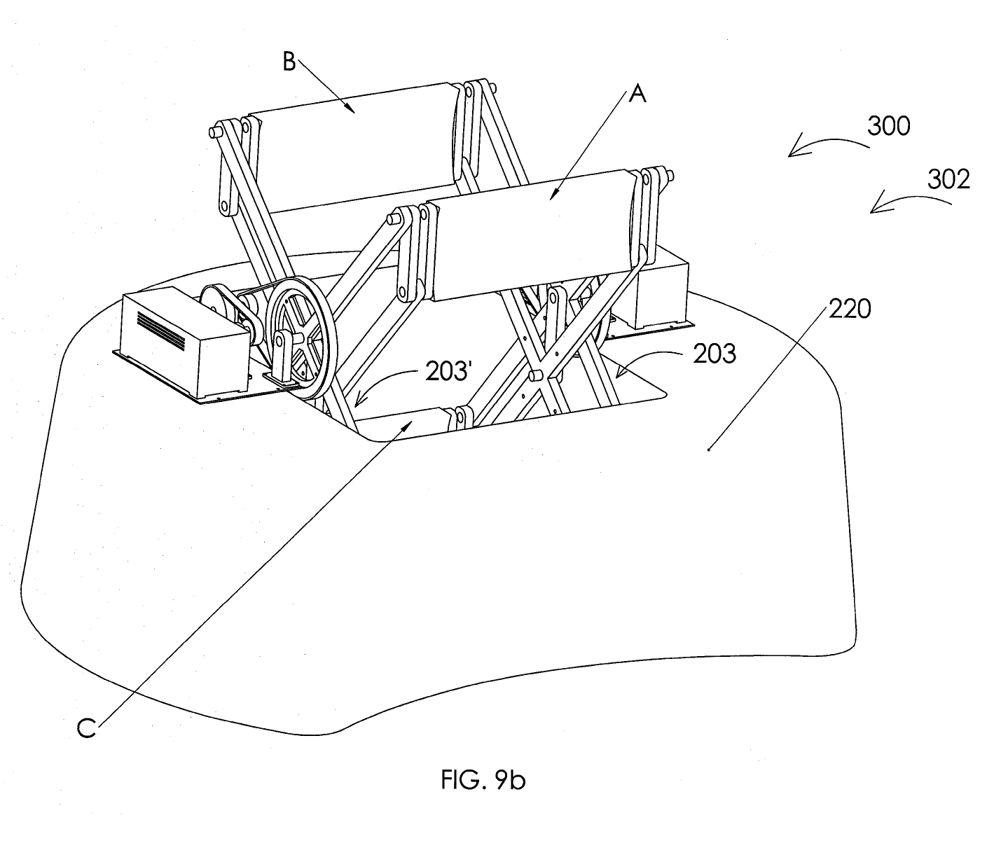

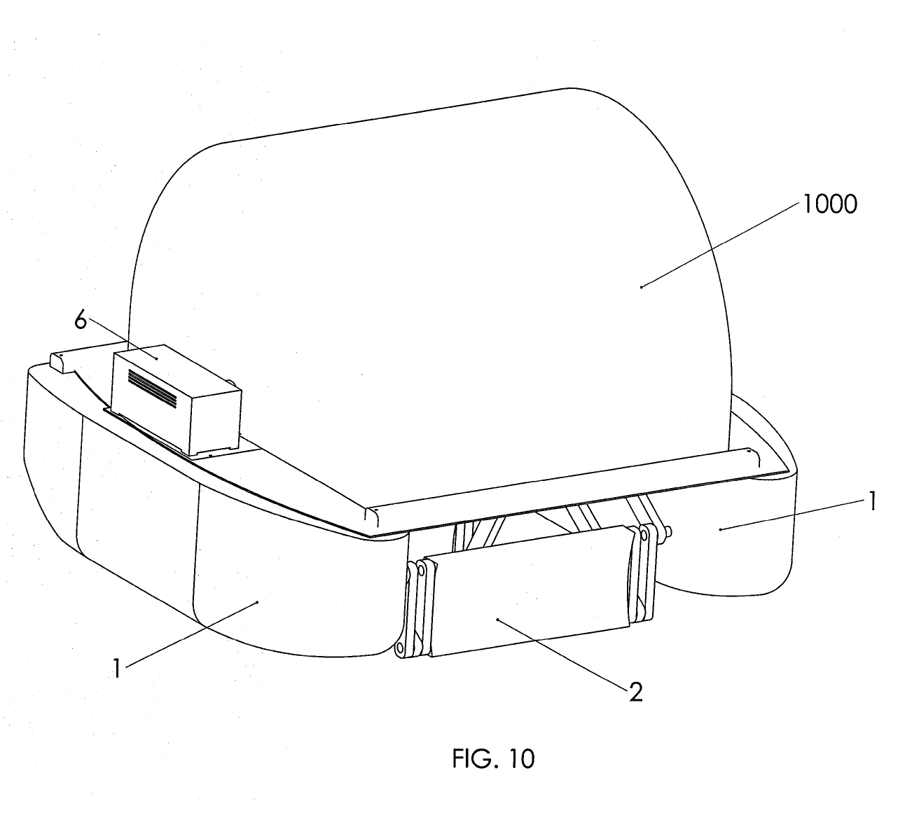

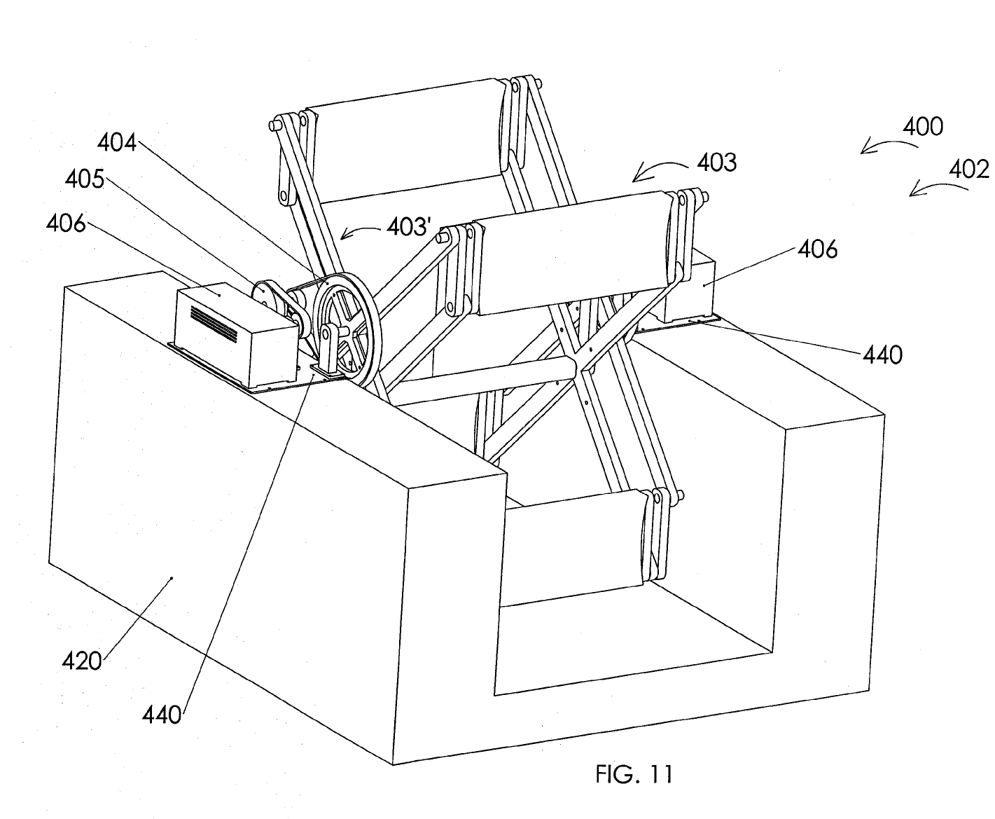

Referring now to FIGS. 9a-9b, there is shown a conversion device 300, according to another embodiment of the invention, for use with air, for converting wind power to rotational power and, possibly, to electricity. Device 300 also has a double turbine 302 formed of two rotating mechanisms 203, 203′ and four flow capturing blades A, B, C and D affixed therebetween. Turbine 302 is substantially the same as turbine 202 shown in FIGS. 7a-7c. It will be appreciated that, since device 300 is powered by wind, device 300 is placed in and powered by only a single fluid. In order to enable a full rotation of the turbine 302, with minimal flow resistance to the flow-capturing blades A, B, C and D while they are rotated opposite to the flow direction, a barrier 220 may be provided to block the wind flow from reaching whichever flow-capturing blade A, B, C or D is currently moving opposite to the wind direction. A portion of barrier 220 is preferably designed with a slope or a ramp with a plateau on top to guide the fluid flow intake towards the blades. This plateau ensures that the ramp flow joins other flows travelling perpendicularly towards the blades. This aerodynamic design of barrier 220 enables high efficiency since it increases the wind flow's velocity.

Barrier 220 is preferably formed with a convex shape that helps position the turbine to face the flow direction. Means, such as a vane, bearing (vertical axis) and/or wheels, can also be provided so that device 300 can self adjust according to the flow direction, to maximize the operation of turbine 302.

It will be appreciated that the design of the device can be configured with the same basic components, in other quantities, shapes and layout. The fact that the flow-capturing blades' velocity is at the same direction as the flow stream minimizes parasite bending loads on the blades, which also enables the device to become light and efficient. Another important structural advantage is tied to the fact that the blades are supported at both ends and not designed as cantilever. This, together with the unique design of the device, allows maximum flexibility and scalability. Preferably, the device is portable, but this is not required

Referring now to FIG. 11, there is shown a conversion device 400 according to another embodiment for converting fluid power to rotational power. Device 400 includes a double turbine 402, substantially the same as turbine 202 shown in FIGS. 7a-7c. In this embodiment, instead of buoys, the rotating mechanisms 403, 403′ and generators 406 are supported by the sides of a channel 420. It will be appreciated that channel 420 can either be a man-made construction or it can be a natural channel, such as the banks of a natural river. Generators 406, gearing systems 405 (if any), wheels 404 and other parts can be mounted on and fixed to a support plate 440. Support plate 440 is rigidly mounted to channel 420 by any appropriate elements, such as bolts or screws. Alternatively, support plate 440 may be omitted and the conversion device may be mounted directly on the banks of the channel 420. Preferably, channel 420 is a u-shaped channel.

Referring now to FIG. 12, there is shown a conversion device 500, according to another embodiment of the invention, for converting fluid power to rotational, electricity or mechanical energy. Device 500 has a single turbine 502 formed of two symmetric bar mechanisms 503, 503′ and two flow capturing blades affixed therebetween. Device 500 is substantially similar to the device shown in FIG. 1. In device 500, instead of two buoys and two generators, a single buoy 501 and a single generator 506 are provided in between rotating bar mechanisms 503, 503′. Rotating bar mechanisms 503, 503′ transfer their rotational energy to generator by using two wheels 504 in a way similar to that described above regarding the device of FIG. 1. In this embodiment, at least one cable (not shown), which may be either a power cable or an anchoring cable, may be attached to device 500. Preferably, this cable is attached to device 500 at one or more of its rotating axles with a fixed or swivel connection so that the rotation of rotating bar mechanisms 503 does not interfere with the cables. Alternately, device 500 may be designed in other configurations, such as with two turbines and four flow capturing blades that are substantially the same as those of device 200 shown in FIGS. 7a-7c.

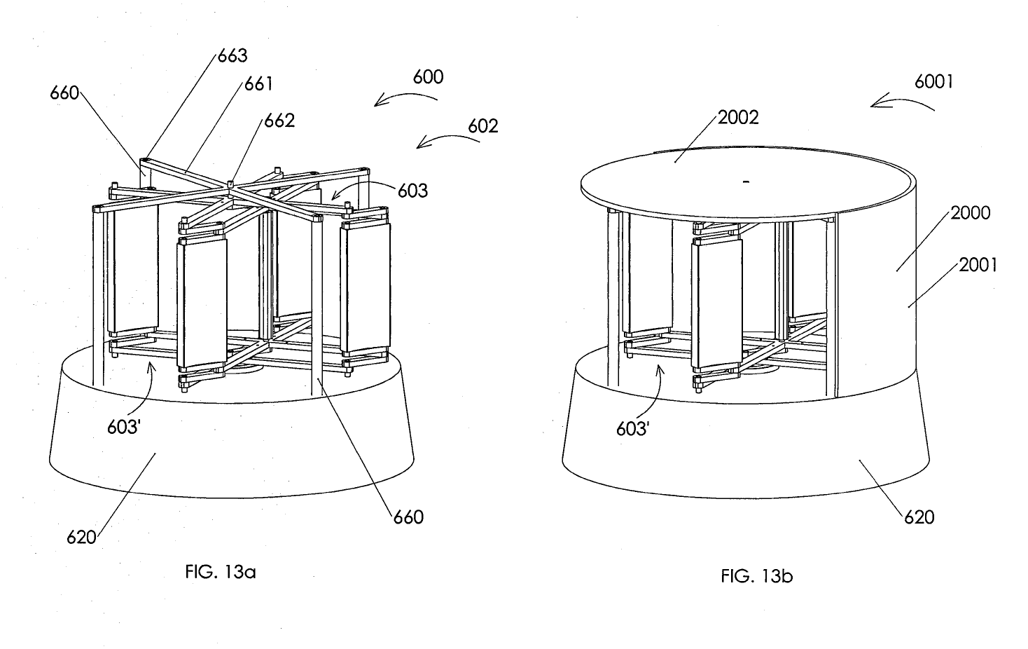

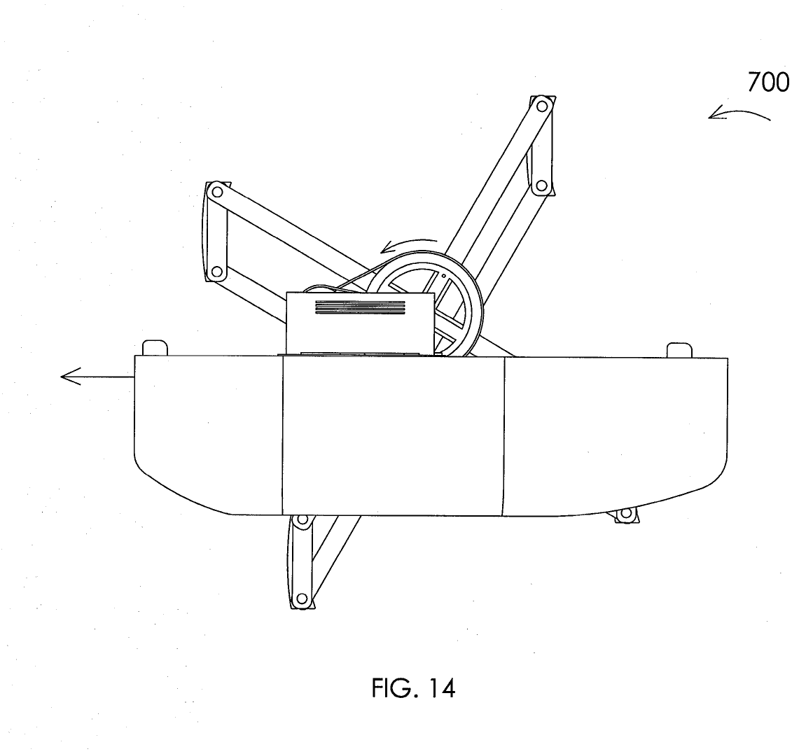

Referring now to FIG. 13a, there is shown a conversion device 600 according to another embodiment for converting fluid power to rotational energy, electricity or mechanical energy. Device 600 includes a double turbine 602 formed of two rotating mechanisms 603, 603′ and four flow capturing blades fixed therebetween. Turbine 602 is substantially similar to turbine 202 shown in FIGS. 7a-7c. In this embodiment, turbine 602 is shown disposed on its side, at a 90° angle to the turbine in FIG. 7a, where the axes are vertical rather than horizontal. In this orientation, as well, the blades of rotating mechanisms 603, 603′ are restrained in a perpendicular orientation in relation to the direction of the fluid flow. The top of turbine 602 may be supported by an x-shaped cross beam 661. X-shaped cross beam 661 is connected at its center to turbine 602 by an axle or shaft 662, so that rotating mechanisms 603, 603′ are supported but are still able to rotate. X-shaped cross beam 661 is rigidly connected at its ends to the tops of support beams 660, as by means of bolts 663. Support beams 660 are rigidly attached at their bottoms to a base 620. The bottom of turbine 602 is attached to or mounted on base 620. This ensures that rotating mechanisms 603, 603′ are supported both at their top by x-shaped cross beam 661 and at their bottom by base 620. A generator (not shown) may be placed inside base 620.

In FIG. 13b, there is shown a conversion device 6001 which is substantially the same as device 600, except that it includes a partial barrier 2000. Barrier 2000 includes a circular cover 2002, which is attached on top of x-shaped cross beam 661, and a circumferential wall 2001 which is attached at its top to circular cover 2002 and at its bottom to base 620. Barrier 2000 may be designed in other ways to enable rotation and minimize resistance when the blades are rotated opposite to the wind direction.

Although the invention is illustrated in the Figures as designed for use in a fluid to convert fluid power to electricity, in addition to generating electricity, alternate uses of the invention are possible. For example, there are other applications of the device where it may be used for other purposes, such as a water pump operated by mechanical energy, or water transportation. It will be appreciated that when not anchored, fluid power can be used to accelerate a craft through the water.

It will also be appreciated that although the turbine has been described above as being operated from its peripheral end to deliver rotation to a shaft in its center, in other embodiments, the turbine can be operated from its shaft at the center to deliver rotation to a peripheral end of the turbine. This operation may be manual or automatic.

In FIG. 14, there is shown one embodiment of a turbine as a driving system to transport the device. The generator may be designed to operate as an electric motor, to rotate the turbine, and pull the blades against the fluid to transport device 700 up river. In other embodiments, the energy source for driving the mechanism may be manual, by the force of a person's foot or any other energy source.

While the invention has been described with respect to a limited number of embodiments, it will be appreciated that many variations, modifications and other applications of the invention may be made. It will further be appreciated that the invention is not limited to what has been described hereinabove merely by way of example. Rather, the invention is limited solely by the claims which follow.

1. A device for converting kinetic energy of a fluid flow to rotational energy, the device comprising:
a pair of rotating bar mechanisms;
at least one flow-capturing blade mounted between the bar mechanisms for enabling rotation of the blade about a central axis;
the bar mechanisms retaining the flow-capturing blade in an orientation substantially perpendicular to a direction of fluid flow, throughout the rotation of the bar mechanism.

2. A device for converting kinetic energy of a fluid flow to electrical or mechanical energy, the device comprising:
a turbine for converting fluid stream energy to rotational energy, said turbine comprising:
a pair of rotating bar mechanisms;
at least one flow-capturing blade fixed between said rotating bar mechanisms,
said turbine enabling rotation of the flow-capturing blade around a central axis of the turbine, while also retaining the blade in an orientation substantially perpendicular to a direction of fluid flow throughout the rotation of the turbine.

3. The device according to claim 2, further comprising a generator coupled to one of said rotating bar mechanisms for converting rotational energy generated by rotation of said blade to electric energy.

4. The device according to claim 2, wherein said turbine includes two pairs of coupling joints, each coupling joint including:
two short vertical bars, each having upper and lower portions;
wherein the lower portions of the short vertical bars are fixedly coupled to a first axle,
wherein the upper portion of a first of said short vertical bars is fixedly coupled to a second axle;
a first rotating long bar pivotally mounted on said first axle in a gap between said short vertical bars; and
a second rotating long bar pivotally mounted on said second axle;
wherein one of said at least one flow-capturing blade is fixedly mounted between the second of said two short bars of one coupling joint and a second of said two short bars of an adjacent joint.

5. The device according to claim 1, further comprising an electric cable for delivering produced energy to an electrical network or to electrical components.

6. The device according to claim 1, further comprising at least one energy storage device for storing produced energy.

7. The device according to claim 1, wherein said blade includes at least one surface having a concave shape.

8. The device according to claim 1, further comprising means for supporting said device above a water level.

9. The device according to claim 1, further comprising a partial barrier, protecting and blocking said flow-capture blade while it is rotated opposite to the flow direction.

10. A method for converting fluid kinetic energy to rotational energy, the method comprising:
providing a turbine including at least one flow-capturing blade mounted between a pair of rotating bar mechanisms for enabling rotation of the flow-capturing blade around a central axis of the turbine;
disposing said turbine in a fluid flow; and
maintaining said flow-capturing blade in an orientation substantially perpendicular to a direction of said fluid flow throughout rotation of the turbine.

11. (canceled)

12. The method according to claim 10, further comprising coupling a rotatable shaft to said turbine.

13. The method according to claim 12, further comprising operating said turbine from a peripheral end to deliver rotation to said shaft.

14. The method according to claim 12, further comprising operating said turbine from the shaft to deliver rotation to a peripheral end of the turbine.

15. The method according to claim 14, further comprising using said rotation as a driving system to transport the device, and coupling a generator to said shaft to operate as an electric motor.

16. The device according to claim 1, further comprising means for supporting said device by sides of a channel and/or in a pipe.

17. The device according to claim 1, further comprising mounting means for mounting the device for rotation about a horizontal axis or about a vertical axis, while the blades of the rotating mechanisms are restrained in a perpendicular orientation in relation to the direction of the fluid flow.

18. (canceled)

19. The method according to claim 10, wherein said step of rotating the turbine frame includes disposing a portion of the turbine in the fluid flow whereby the fluid flow pushes the flow-capturing blades.

20. The method according to claim 10, comprising operating the turbine by mechanically rotating the turbine frame, thereby pulling the flow-capturing blades against the fluid flow.

21. The method according to claim 10, wherein the step of disposing includes disposing the turbine in a fluid flow such that its axes are horizontal, while the blades of rotating mechanisms are restrained in a perpendicular orientation in relation to the direction of the fluid flow.

22. The method according to claim 10, wherein the step of disposing includes disposing the turbine in the fluid flow such that its axes are vertical, while the blades of rotating mechanisms are restrained in a perpendicular orientation in relation to the direction of the fluid flow.
